(19) United States
(12) Patent Application Publication
(10) Pub. No.: US 2025/0277446 A1
(43) Pub. Date: Sep. 4, 2025

(54) System and Method for the Robotic Loading of Explosives in Underground Mining

(71) Applicant: Enaex Servicios S.A., Santiago (CL)

(72) Inventors: Marco Antonio Ruiz Hernandez, Santiago (CL); Rodrigo Miranda Lorca, Santiago (CL); Jonhatan Barriga Melgarejo, Santiago (CL); Gloria del Pilar Lara Marro, Santiago (CL); Danko Christian Morales Garrido, Santiago (CL); Felipe Andres Prado Figueroa, Santiago (CL)

(73) Assignee: Enaex Servicios S.A., Santiago (CL)

(21) Appl. No.: 18/252,523

(22) PCT Filed: Nov. 13, 2020
(86) PCT No.: PCT/CL2020/050153

§ 371 Date: May 10, 2023

(51) Int. Cl. E21C 41/16; E21B 37/00

(52) U.S. Cl. CPC E21C 41/16; E21B 37/00; E21C 2200/00

(57) ABSTRACT

A system and process for the robotic loading of explosives in underground mining, wherein the system can be operated autonomously, semi-autonomously or by remote operation. The system comprises: a positioning subsystem comprising means for moving the system by autonomous navigation; a subsystem for cleaning a base, which comprises means for removing unwanted elements that may obstruct the operation of loading explosives in the boreholes; a subsystem for scanning a loading surface, which comprises detection means for detecting boreholes in a drilled surface and assigning a location for each borehole; a borehole drilling subsystem comprising means for determining physical parameters of each borehole; a priming and loading subsystem comprising means for loading a booster, detonator and other explosive materials, placing them at the bottom of each borehole; a subsystem for loading the blasting agent, which comprises means for supplying a blasting agent once the explosives have been placed in each borehole; a borehole-sealing subsystem comprising means for covering each borehole once the explosives have been loaded; a detonation subsystem comprising means for detonating each borehole loaded with explosives; and a control subsystem that communicates with each of the other subsystems and controls each of the elements for loading and detonating the explosives.

### FIELD OF THE INVENTION

The present invention relates to systems and equipment used for tunnel development, and more specifically to different technologies associated with drilling and blasting. In particular, a robotic system for loading explosives in underground drilling and blasting is described.

### BACKGROUND OF THE INVENTION

Many high-risk tasks are currently carried out in person in the mining industry with the assistance of multiple workers, who must work in dangerous areas. In the case of explosives loading in underground mining, tasks must be carried out by crews of workers at the blasting site, where such tasks include, for example, inspection and cleaning of the front and the respective boreholes, priming tasks and insertion of detonators and explosives in each borehole and the connection of all detonators.

Each of the above-mentioned tasks constitutes a high risk for personnel due to multiple reasons. First of all, these tasks are performed manually at the blasting front, exposing personnel to possible rock falls or bursts or other events that can cause serious injuries to personnel, such as cuts, bruises, fractures, and even death in the most serious cases.

On the other hand, there are other risks associated with the presence of personnel in blasting areas. For example, after each blasting there is a ventilation period that can vary from 1 to 5 hours, depending on the conditions of each mine and the level of existing gases, during which personnel cannot access the area. These ventilation times involve a period of non-activity in the area, which turns into a productivity reduction.

Along the same lines, there are areas in mining sites that are unstable and have the potential for landslides, which prevents personnel from accessing these areas to mine the ore. Thus, the mine productivity is significantly reduced, since even when there are areas with valuable resources, many of these areas remain unexploited due to the high risk to personnel.

The need to carry out the mentioned tasks of loading explosives by hand requires the collaboration of multiple operators and personnel trained to handle explosives. Commonly, a drilling machine carries out the perforation of the boreholes in the front to be drilled based on a pre-planned blasting plan. A crew of operators then enters the area to load the explosives and performs a visual inspection of the condition of the blasting front. In the event that the front is very dirty, the operators clean it manually, clearing the base with shovels to unclog the boreholes that could have been obstructed. Once this task is finished, the operators must manually insert the detonators into the respective boosters or “boosters” (priming operation) and then insert each set into the corresponding borehole. This insertion action is commonly carried out by pushing a bar or long wooden rod, trying to leave the detonator cable outside the borehole for the subsequent blasting thereof.

Furthermore, many of the boreholes are located above ground, so they shall be loaded with the aid of an elevator commonly known as a “manlift”, which lifts the operator to reach the height of the upper boreholes, which can be up to 8 meters high. Once this task is completed, a new crew enters to load a blasting agent (or ANFO) into each borehole, covering each primer and thus completing the explosive charge. Finally, the cables are tied together to be operationally connected to a main cable or “fuse”, which will be in charge of starting the blast.

As can be seen from the above description, currently the complete process of loading explosives involves a large amount of tasks that shall be carried out by multiple people—duly qualified for these actions. All these efforts result in a large number of man-hours and high risks for the personnel involved in these operations, and even their lives may be compromised.

Due to these limitations, there is a need in the current state of the art for a system that can carry out all the tasks associated with the loading of explosives autonomously, semi-autonomously or by remote operation, so as to completely avoid the intervention of people in the blasting area.

### BRIEF DESCRIPTION OF THE INVENTION

To overcome the above-mentioned drawbacks, a system for loading explosives in underground mining is provided, which can be operated autonomously, semi-autonomously or by remote operation, said system comprising:
a positioning subsystem comprising means for moving the system by autonomous or semi-autonomous navigation or by remote operation;
a subsystem for cleaning a base, which comprises means for removing unwanted elements that may obstruct the operation of loading explosives in the boreholes;
a subsystem for scanning a loading surface, which comprises detection means for detecting boreholes in a drilled surface and assigning a location for each borehole;
a borehole drilling subsystem comprising means for determining physical parameters of each borehole;
a priming and loading subsystem comprising means for loading a booster, detonator, and other explosive materials, placing them at each borehole;
a subsystem for loading the blasting agent, which comprises means for supplying a blasting agent once the explosives have been placed in each borehole;
a borehole-sealing subsystem comprising means for covering each borehole once the explosives have been loaded;
a detonation subsystem comprising means for detonating each borehole loaded with explosives, and
a control subsystem that communicates with each of the other subsystems.

The system for loading explosives can be implemented in all types of underground workings or underground mining applications involving explosives, such as front loading, vertical loading or ditching.

In those applications in which the invention is implemented on a front, the system may further comprise a mesh opening and guiding subsystem in those cases where a reinforcement mesh is provided with the boreholes on the front, in order to allow the operation of the different elements of the system through the mesh.

In this way, by using the above-described configuration it is possible to carry out each of the explosives loading tasks, from start to finish, without the intervention of personnel in the blasting area. Thus, the described system can operate either completely autonomously, semi-autonomously or through remote operation by duly trained personnel.

In relation to the current state of the art, the developed system allows eliminating the risks associated with the manual execution of each of the explosives loading tasks completely, which are related, for example, to possible rock falls and explosions or exposure to gases in the blasting zones, etc. Furthermore, since the system is not affected by the presence of post-blasting gases, it can operate in period of times that are within the ventilation period, which can significantly increase the productivity periods.

Another fundamental advantage of the present invention in relation to the current state of the art is the possibility of accessing areas that are considered unstable, which are currently inaccessible due to potential risks for personnel. The possibility of the system of being able to access these areas can represent a significant increase in the mine productivity, since it opens the possibility of exploiting valuable resources that are currently unavailable.

On the other hand, although in the state of the art it is possible to find automated systems that facilitate some of the operations related to the loading of explosives such as drilling equipment, equipment for the loading of blasting agents, elevators, etc., this equipment only allows solving—in an automated way, some of the operations related to the loading of explosives. In contrast, the present invention allows gathering in a single system a plurality of elements that act together and synergistically to carry out each and every one of the tasks necessary to complete the loading of explosives, without exposing persons to potential risks.

### BRIEF DESCRIPTION OF THE FIGURES

FIG. 1 shows an isometric view of one of the embodiments of the system for loading explosives of the present invention.

FIG. 2 shows a side elevation view of a configuration of the system for the loading of explosives of the present invention.

FIG. 3 shows an enlarged view of a section of the system configuration for loading explosives of FIG. 2.

### DETAILED DESCRIPTION OF THE INVENTION

According to the embodiments shown in the attached figures, the present invention consists of a system (100) for loading explosives on a loading surface (200) of underground mining, which can be operated autonomously, semi-autonomously or by remote operation, and comprises:
a positioning subsystem comprising means for moving the system by autonomous or semi-autonomous navigation or by remote operation;
a subsystem for cleaning a base, which comprises means for removing unwanted elements that may obstruct the operation of loading explosives in the boreholes;
a subsystem for scanning a loading surface, which comprises detection means for detecting boreholes in a drilled surface and assigning a location for each borehole;
a borehole drilling subsystem comprising means for determining physical parameters of each borehole;
a subsystem for cleaning boreholes comprising means for cleaning each borehole in order to proceed with the loading of explosives;
a priming and loading subsystem comprising means for loading a booster, detonator, and other explosive materials, placing them at each borehole;
a subsystem for loading the blasting agent, which comprises means for supplying a blasting agent once the explosives have been placed in each borehole;
a borehole-sealing subsystem comprising means for covering each borehole once the explosives have been loaded;
a detonation subsystem comprising means for detonating each borehole loaded with explosives; and
a control subsystem that communicates with each of the other subsystems and controls each element for loading and detonating the explosives.

The invention can be implemented in all types of underground workings or underground mining applications involving explosives. However, for illustrative purposes the detailed description of the invention will be carried out in terms of the attached figures, which refer to the loading of explosives in a front (200) of underground mining.

In this way, in preferred embodiments of the invention the system may further comprise a mesh guiding and opening subsystem in those cases where a reinforcement mesh is provided with the boreholes on the front, in order to allow the operation of the several elements of the system through the mesh. Particularly, the mesh guiding and opening subsystem may preferably comprise a device in the form of a speculum (not shown in the Figures) which consists of two or more pieces that are opened by a driving mechanism, thereby deforming the mesh, and creating the space for passing the elements of the system that are used for loading the explosive. This system may also include a cutting tool in case there is not enough space for the insertion of the speculum.

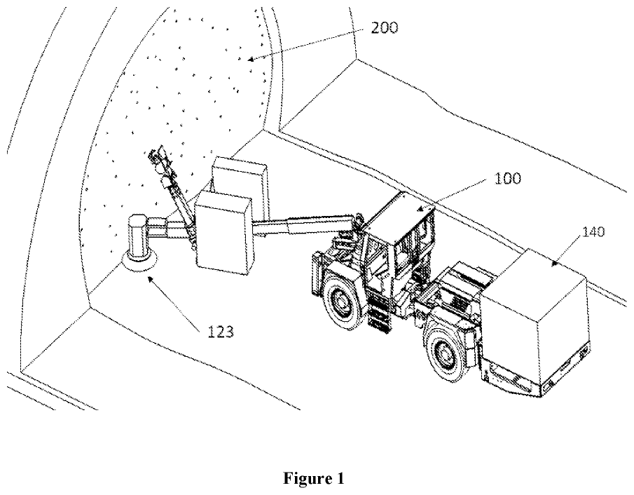

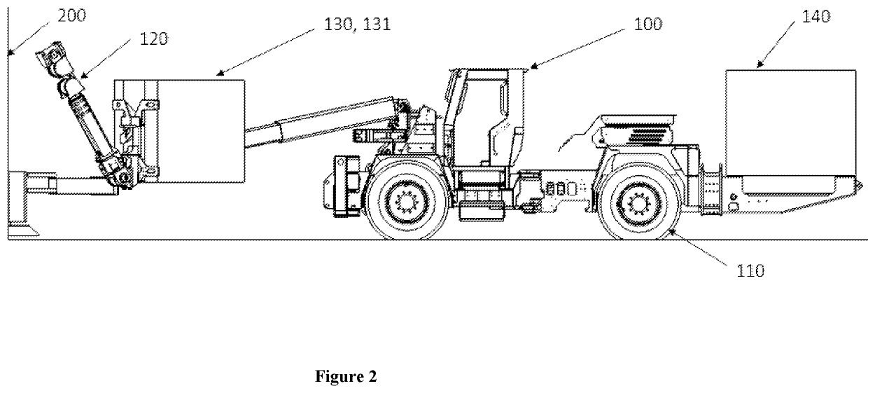

As shown in FIGS. 1 and 2, the positioning subsystem comprises means for moving (110) the complete system, for example, being arranged in a vehicle operated by autonomous navigation, which can be moved by wheels or tracks, and can be powered by electricity, fuel or by the use of batteries. Furthermore, the positioning subsystem comprises means for moving and placing different elements that conform the system for loading explosives, such as for example the use of robotic arms (120) and hoses (not shown in the figures) which can be driven through hydraulic, pneumatic, or electrical systems.

The positioning subsystem communicates with the control subsystem, which has a map of the blasting zone in which the system is operating, and from this map the positioning subsystem allows the driving of different means to move each of the elements that are necessary for the different tasks. In this way, the positioning subsystem allows the movement of the complete system autonomously within the underground work site, by using the map provided by the control subsystem.

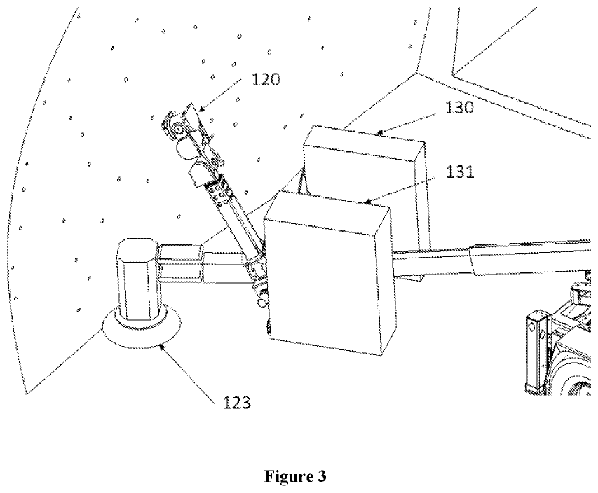

In turn, as shown in FIGS. 1 and 3, the subsystem for cleaning the base comprises means (123) that allow the removal of debris or residues from the boreholes, which exist in the base or lower area of the front (commonly referred to as the “lifter”) in order to clear the boreholes that may be obstructed by such debris. Preferably, the means for cleaning debris may comprise the use of hoses supplying pressurized water and/or air, or such means may comprise the use of moving elements, such as moving brushes that remove debris.

The front scanning subsystem comprises the use of sensors that allow a three-dimensional scanning of the loading front, which allow detecting each individual borehole. Even in cases where a wire mesh safety screen is placed to prevent rockslides, the front scanning subsystem is able to detect boreholes through the mesh. Through this scanning the subsystem detects each borehole and assigns them a location within a digital model.

In particular, the subsystem may include the use of LIDAR sensors, TOF sensors, cameras, and others, which may be moved by hydraulic arms, wherein the arm is capable of being moved in different positions in order to carry out the scanning of the entire front. In this way, the sensor(s) used can be arranged in different locations within the system, and preferably they are placed at the base of the robotic arm(s) (120).

In a preferred embodiment of the invention, the subsystem performs a general scan of the front using one or more LIDAR sensors and a supporting camera to assign the location of the boreholes. Subsequently, the scanning subsystem divides the front into sectors, and the robotic arm on which the scanning subsystem is mounted is placed in front of each sector. At this point a scan of the specific sector selected by using the LIDAR sensor and the support camera is carried out, and then the scan results are compared with a pre-existing borehole diagram from the drilling stage. In the event that discrepancies are detected after such a comparison, for example, in case the sensor did not detect a borehole present in the pre-existing diagram, the front scanning subsystem uses the TOF sensor or camera. In this case, the TOF sensor is placed closer to the area, where the undetected borehole should be, in order to identify the same.

In relation to the borehole drilling subsystem, this preferably comprises the use of an inertial sensor that allows establishing parameters such as the length and inclination of the borehole.

Preferably, the borehole cleaning subsystem also comprises means to identify the state of cleanliness of each borehole and to clean each borehole, in order to proceed with the loading of explosives.

As shown in more detail in FIGS. 2 and 3, the priming and loading subsystem preferably comprises the use of a priming device (not shown in the figures), one or more robotic arms (120), one or more pushing means, a booster container or “boosters” (130) and a detonator container (131). Preferably, the priming device may be located on the robotic arm or in an area adjacent thereto, and the same robotic arm is responsible for taking a booster from a booster container (130) to place the same in the priming device, and subsequently removing a detonator from a detonator container (131) to place it in front of the booster in the priming device to then locate the primed object at the end of the robotic arm. In this way, the priming and loading subsystem comprises a specialized mechanism that allows carrying out the “priming” operation consisting of properly coupling the detonator with the respective booster, once both components are located in the priming device. Subsequently, by means of the robotic arm (120) the primer is placed inside a respective borehole in the front, and the same is pushed by means of the pushing means, then the blasting agent is loaded, and a detonator antenna is placed outside the borehole, which is intended to be subsequently used by the detonation subsystem. Preferably, the pushing means corresponds to a flexible hose; however, other means are contemplated within the invention, such as rods or others.

In preferred embodiments of the invention, the priming and loading subsystem may further comprise the loading of additional explosive elements, such as for example dynamite-type explosives. In this embodiment, the priming and loading subsystem places different dynamite devices in the boreholes at the ends of the front referred to as the “crown” of the front. In these boreholes, the priming and loading subsystem places the dynamite devices inside the boreholes after loading the primer instead of loading a blasting agent.

The dynamite devices commonly consist of elongated cartridges that are connected to each other in series, covering a large part of the length of the borehole. In this way, the priming and loading subsystem comprises means that allow the dynamite devices to be connected in series, one after the other, and that also allow the insertion of the same in each borehole. The number of dynamite devices to be connected depends on the length of each borehole.

In those boreholes where dynamite devices are not inserted, the subsystem for loading the blasting agent acts, which preferably can use the same hose used in the explosives loading for the supply of a blasting agent to each borehole of the front. For this purpose, the subsystem for loading the blasting agent comprises blasting-agent container means, and pressurization means that allow the supply of blasting agents through the hose. In this way, after the priming and loading subsystem has properly placed the primer or explosive elements, the hose is actuated to move backwards into each borehole, at the same time as the blasting agent is being delivered through the hose.

As shown in FIGS. 1 and 2, the subsystem for loading the blasting agent preferably further comprises a system for preparing the blasting agent (140), which is intended to house the necessary components for preparing the blasting agent, preparing the mixture of blasting agents, and allow the supply of blasting agent to each of the boreholes in the front. In this way, the system for preparing the blasting agent (140) allows the on-site manufacture of the blasting agent or ANFO (Ammonium Nitrate-Fuel Oil), with any type of components required and in any of the proportions necessary for a given operation.

The system for the manufacture of the blasting agent (140) preferably comprises containers housing the components for the manufacture of the blasting agent or a single container comprising internal divisions to house the various components within respective compartments. The system further comprises pumping means, which provide the necessary pressure for the transfer of the components to a mixing means, and which subsequently allow the prepared mixture to be transferred to each of the boreholes in the front. Once the mixing process is completed, the already-prepared blasting agent can be transferred through the respective hoses to the front boreholes with the help of the robotic arms (120).

The system for preparing the blasting agent (140) further communicates with the control subsystem, which allows the programmable control of the preparation process of blasting agent. In this way, by using the control subsystem, the blasting agent can be prepared and supplied automatically, by local or remote operation.

The borehole sealing subsystem consists of the utilization of means that allow the introduction of inert material, which may preferably consist of some type of foam, or other type of materials. In this way, said means cover the exposed end of each borehole, thus generating a seal or plug after the operation of loading explosives is finished. The means used in this subsystem are preferably placed at the end of the robotic arm (120).

Preferably, the detonation subsystem consists of a wireless detonation system, which comprises a detonator antenna activator. In particular, the detonation subsystem comprises means that enable activation of the antennas located on each of the detonators of each borehole, such as through optical means, such as a coded light beam or by means of any other type of wireless signal, thus providing the delay information of each detonator and performing the detonation from the control subsystem. However, it should be taken into consideration that the invention also includes the possibility of carrying out wired detonation processes, in general.

Furthermore, while the various subsystems have been described in terms of the use of a robotic arm (120) comprising means necessary to execute the operations of explosives loading at the front of the underground workings, the system may optionally comprise the use of two or more robotic arms that can operate simultaneously, so as to allow simultaneous or programmed explosives loading in different boreholes.

The present invention further comprises a process for the loading of explosives in an underground mining site, the process comprising the steps of:
a) positioning the system for loading explosives inside an underground mining site by means of semi-autonomous or autonomous navigation, or by remote operation;
b) carrying out a process for cleaning the base of the front in order to remove unwanted elements that may obstruct the entry of explosives into the boreholes;
c) scanning the loading surface to detect each borehole and assign a location for each of them;
d) performing an evaluation of the interior of each borehole in order to establish physical parameters thereof;
e) carrying out a priming operation by combining detonators with respective boosters and loading each primer into a respective borehole;
f) positioning a detonator antenna outside each borehole;
g) loading a blasting agent into each borehole and executing a sealing operation of each borehole, positioning then an antenna at the end of each borehole, and
h) activating the antennas of each detonator by means of a wireless signal so as to cause the detonation in each borehole.

Additionally, the process comprises the step of executing a mesh opening, in those cases where a reinforcement mesh is provided over the front with the boreholes, in order to allow the operation of the various elements of the system through the mesh. In particular, the step of executing a mesh opening comprises the use of a device in the form of a speculum, which allows deforming the mesh and creating enough space so that the various elements of the system used for loading the explosives can pass through. Furthermore, this step may include the action of cutting a section of the mesh, in the event that there is insufficient space for the insertion of the speculum.

Preferably, the step of positioning the system for loading explosive comprises the actuation of means for the mobilization of the system based on a map of the blasting zone provided by the control subsystem, thus allowing the movement of the complete system within the underground mining site autonomously.

Similarly, the process for cleaning the front base comprises the actuation of means that allow the removal of debris or residues from boreholes present at the base or lower area of the front, in order to clear the boreholes that may be obstructed by such debris.

The front scanning process includes the steps of using sensors to perform a three-dimensional scan of the loading front to detect each borehole and assign a location to them. In particular, this process includes the specific steps of.
a) carrying out a general scan of the front using LIDAR sensors and a back-up camera to map the location of the boreholes;
b) dividing the front into sectors and placing the sensors in each sector in order to scan the specific sector;
c) comparing the scan results with a pre-existing borehole diagram; and
d) in the event that discrepancies are detected, using a sensor or TOF camera that is available closer to the area where the discrepancy was found, in order to identify a borehole.

Concerning the step of performing an evaluation of the interior of each borehole, this includes the step of using an inertial sensor to establish physical parameters of the borehole, such as borehole length and inclination, and supplying pressurized air to perform a cleaning of each borehole.

Furthermore, the step of performing an evaluation of the interior of each borehole preferably includes the step of identifying the cleanliness state of each borehole and cleaning each borehole to proceed with the loading of explosive. In this embodiment, flexible elements can be used, such as, for example, hoses to supply pressurized fluid, such as water or air/water mixtures.

In relation to the priming and loading process, this includes the steps of:
a) taking a booster and a detonator from their respective containers to place them in a priming device;
b) using a specialized mechanism that allows carrying out the operation of priming, properly coupling the detonator with the respective booster;
c) positioning each primer inside a respective borehole, and push it through a loading hose; and
d) positioning a detonator antenna on the outside of each borehole.

Furthermore, in optional embodiments of the invention, the priming and loading process includes the steps of:
e) taking a dynamite device from a container;
f) coupling two or more dynamite-type devices in series, depending on the amount of recorded length of each borehole;
g) inserting dynamite devices into selected boreholes at the ends of the front.

In those boreholes in which dynamite devices are not inserted, the step of loading a blasting agent is carried out, which includes the actuation of means for supplying a blasting agent in each borehole through the loading hose. Furthermore, the sealing operation of each borehole consists in the use of means that introduce inert material covering the exposed end of each borehole, thus generating a seal or plug after the operation of loading explosives is finished.

Finally, it should be noted that various particular parameters of the invention, such as dimensions, choice of materials, and specific aspects of the above-described preferred embodiments may vary or be modified depending on operation requirements. Accordingly, the description of the above-described specific embodiments are not intended to be limiting, and such variations and/or modifications are within the spirit and scope of the invention.

1-40. (canceled)

41. A system for loading explosives into a loading surface of an underground mining site, wherein the system comprises:
a positioning subsystem comprising means for moving the system;
a loading-surface cleaning subsystem comprising means for removing unwanted elements that obstruct the operation of loading explosives in the boreholes;
a scanning subsystem of the loading surface comprising detection means for detecting boreholes in the drilled surface and assigning a location for each borehole;
a borehole drilling subsystem comprising means for determining physical parameters of each borehole;
a borehole cleaning subsystem comprising means for cleaning each borehole to proceed with the loading of explosives;
a priming and loading subsystem comprising means for loading a booster, detonator, and/or other explosive materials, placing them in each borehole;
a subsystem for loading a blasting agent comprising means for supplying a blasting agent after explosives have been placed in each borehole;
a borehole sealing subsystem comprising means for covering each borehole after the operation of loading explosives is finished;
a detonation subsystem comprising means for detonating each borehole loaded with explosives; and
a control subsystem that communicates with each of the other subsystems and controls each of the elements for loading and detonating the explosives.

42. The system of claim 41 further comprising a mesh guiding and opening subsystem for those cases in which a reinforcement mesh is provided on the loading surface, which allows the operation of the different elements of the system through the mesh.

43. The system of claim 42 wherein the mesh guiding and opening subsystem comprises a device in the form of a speculum comprising two or more pieces that are opened by a driving mechanism, deforming the mesh, and creating space for system elements to pass through.

44. The system of claim 43 wherein the mesh opening and guiding subsystem further comprises a cutting tool, for those cases where there is insufficient space for insertion of the speculum-shaped device.

45. The system of claim 41 wherein the positioning subsystem comprises a vehicle operated by at least one of autonomous navigation, semi-autonomous navigation, and remote operation, and comprises means for moving and placing the various elements comprising the system for loading explosives.

46. The system of claim 45 wherein the positioning subsystem operates by utilizing a map of the area, which is provided by the control subsystem, from which the positioning subsystem actuates various elements to move the system autonomously or semi-autonomously within the underground mining site.

47. The system of claim 41 wherein the loading-surface cleaning subsystem comprises means for removing debris or residue at the base or bottom area of the surface.

48. The system of claim 47 wherein the means for cleaning debris are selected from a group comprising:
the use of hoses supplying pressurized water and/or air; or
the use of movable elements in the form of brushes and/or shovels.

49. The system of claim 41 wherein the scanning subsystem of the loading surface comprises sensors that scan the surface three-dimensionally, and detect each borehole and assign a location within a digital model.

50. The system of claim 49 wherein the sensors are moved by robotic arms, and wherein the arm moves in different positions to scan the entire surface.

51. The system of claim 50 wherein the subsystem includes the use of LIDAR sensors, TOF sensors, cameras, and others.

52. The system of claim 41 wherein the borehole drilling subsystem comprises an inertial sensor that establishes parameters such as borehole length and inclination, and wherein the sensor is placed at the end of a drilling element that allows various measurements to be made as the sensor is inserted into each borehole.

53. The system of claim 52 wherein the borehole cleaning subsystem comprises means for identifying the state of cleanliness of each borehole and for cleaning each borehole to proceed with the loading of explosives.

54. The system of claim 41 wherein the priming and loading subsystem comprises a priming device, one or more robotic arms, a booster container, and a detonator container, and wherein the robotic arm takes a booster from the booster container to place the booster in the priming device, and takes a detonator from the detonator container to place it in front of the booster in the priming device to perform a priming operation and then place the primed object at the end of the robotic arm.

55. The system of claim 54 wherein the priming and loading subsystem further comprises a mechanism that performs the priming operation, which couples the detonator with the booster inside the priming device.

56. The system of claim 55 wherein the robotic arm positions the primed object to the interior of a borehole in the surface by using pushing means that push the primed object into the borehole.

57. The system of claim 54 wherein the priming and loading subsystem further comprises loading dynamite-type explosive element, and wherein the priming and loading subsystem positions the dynamite elements in the boreholes at the ends of the surface and includes means for serial insertion and connection of different dynamite-type devices in each borehole.

58. The system of claim 56 wherein, after the primed object has been placed, the loading subsystem of a blasting agent actuates a hose to move back in the borehole and simultaneously supplies a blasting agent, loading the blasting agent as the hose is withdrawn from the borehole.

59. The system of claim 58 wherein the subsystem for loading the blasting agent comprises blasting-agent containers and pressurization means that allow supplying the blasting agent through the hose.

60. The system of claim 58 wherein the subsystem for loading the blasting agent comprises a system for preparing the blasting agent comprising means for housing the components required for the manufacture of the blasting agent, preparing the mixture of said components, and allowing the supply of the blasting agent to each borehole on the surface.

61. The system of claim 60 wherein the system for manufacturing the blasting agent comprises containers that house the components for manufacturing the blasting agent, mixing means, and pumping means that allow the components to be transferred to the mixing means and to transfer the mixture to each borehole at the surface.

62. The system of claim 61 wherein the system for manufacturing the blasting agent further comprises hoses that enable the transfer of the prepared blasting agent towards the boreholes on the surface, with the aid of the robotic arms.

63. The system of claim 62 wherein the system for preparing the blasting agent communicates with the control subsystem, which allows to automatically control the process of blasting agent preparation.

64. The system of claim 41 wherein the borehole sealing subsystem comprises means covering the end exposed from each borehole, generating a seal or plug after the operation of loading explosives is finished.

65. The system of claim 64 wherein the means covering each borehole are placed at the end of a robotic arm.

66. The system of claim 41 wherein the detonation subsystem comprises means that enable the activation of antennas that are placed on the detonators on the outside of each borehole.

67. The system of claim 66 wherein the detonation subsystem comprises the use of wireless and wired detonation systems.

68. The system of claim 66 wherein the used means are based on optical signals, a coded light beam, or other wireless signals.

69. A method for loading explosives in a loading surface of an underground mining site, wherein the method comprises the steps of:
positioning a system for loading explosives inside an underground mining site;
cleaning the base of the loading surface in order to remove unwanted elements that obstruct the entry of explosives into the boreholes;
scanning the loading surface to detect each borehole and assign a location for each of them;
evaluating the interior of each borehole in order to establish physical parameters thereof;
priming by combining detonators with boosters and loading each primer into a respective borehole;
positioning a detonator antenna outside each borehole;
loading a blasting agent into each borehole and executing a sealing operation of each borehole;
positioning an antenna at the end of each borehole; and
activating the antennas by means of a wireless signal so as to cause the detonation in each borehole.

70. The method of claim 69 further comprising the step of executing a mesh opening, in those cases in which a reinforcement mesh is provided with the boreholes on the front, which allows the operation of the different elements of the system through the mesh.

71. The method of claim 70 wherein the step of making a mesh opening comprises deforming the mesh by means of a device in the form of a speculum, or cutting a section of the mesh so as to create a space through which the various elements of the system used for loading explosives can pass.

72. The method of claim 69 wherein the step of positioning the system for loading explosives comprises actuating means for moving the system by virtue of a map of the blasting zone provided by the control subsystem.

73. The method of claim 69 wherein the step of cleaning the base of the loading surface comprises actuating means for removing drilling debris or residues in the base or lower zone of the loading surface.

74. The method of claim 69 wherein the step of scanning the loading surface includes the steps of using sensors to scan the loading surface three-dimensionally to detect each borehole and assigning a location to each borehole.

75. The method of claim 74 wherein the step of scanning the loading surface includes the steps of:
scanning the surface using LIDAR sensors and a back-up camera in order to assign the location of the boreholes;
dividing the surface into sectors and placing the sensors in each sector in order to scan the specific sector;
comparing the scan results with a pre-existing borehole diagram; and
in the event that discrepancies are detected, using a sensor or TOF camera that is available closer to the area where the discrepancy was found, in order to identify a borehole.

76. The method of claim 69 wherein the step of evaluating the interior of each borehole includes the step of using an inertial sensor to establish physical parameters of the borehole and supplying pressurized fluid such as water or a mixture of water and air to perform a cleaning of each borehole.

77. The method of claim 69 wherein the step of priming and loading comprises the steps of:
taking a booster and a detonator from their respective containers to place them in a priming device;
using a mechanism to perform the priming thereby coupling the detonator with the respective booster;
positioning each primer inside a respective borehole, and push it through a loading hose; and
positioning a detonator antenna on the outside of each borehole.

78. The method of claim 69 wherein the step of priming and loading further comprises the steps of:
taking a dynamite device from a container;
coupling two or more dynamite-type devices in series, depending on the amount of recorded length of each borehole; and
inserting dynamite devices into selected boreholes at the ends of the front.

79. The method of claim 77 wherein the step of loading a blasting agent comprises actuating means for supplying a blasting agent to each of the boreholes through the hose used in loading explosives.

80. The method of claim 69 wherein the sealing operation of each borehole comprises using means that introduce inert material covering the exposed end of each borehole, generating a seal or plug after the operation of loading explosives is finished.
